(19) United States
(12) Patent Application Publication
(10) Pub. No.: US 2017/0004595 A1
(43) Pub. Date: Jan. 5, 2017

(54) REWARDING A USER FOR PROVIDING SAFETY HAZARD INFORMATION

(71) Applicant: The Boeing Company, Chicago, IL (US)

(72) Inventors: Liisa C. Bruchal, Seattle, WA (US); William A. Harkness, Mukilteo, WA (US)

(73) Assignee: The Boeing Company

(21) Appl. No.: 14/788,540

(22) Filed: Jun. 30, 2015

(51) Int. Cl. G06Q 50/26; G06K 19/06; G01S 19/42

(52) U.S. Cl. CPC G06Q 50/265; G01S 19/42; G06K 19/06037

(57) ABSTRACT

In an example, a method includes receiving, at a server from a first computing device, safety hazard information associated with a first location. The method also includes determining, at the server, a hazard response operation to be performed based on the safety hazard information. The method further includes determining, at the server, a reward to be provided to a user associated with the first computing device for providing the safety hazard information.

### FIELD OF THE DISCLOSURE

The present disclosure is generally related to rewarding a user for providing safety hazard information.

### BACKGROUND

There may be challenges associated with identifying/remedying safety hazards (e.g., in a workplace environment). Further, there may be challenges associated with efficiently organizing a response to an emergency situation (e.g., in a workplace environment).

### SUMMARY

In a particular embodiment, a method includes receiving, at a server from a first computing device, safety hazard information associated with a first location. The method also includes determining, at the server, a hazard response operation to be performed based on the safety hazard information. The method further includes determining, at the server, a reward to be provided to a user associated with the first computing device for providing the safety hazard information.

In another particular embodiment, a system includes a processor and a memory in communication with the processor. The memory includes instructions that are executable by the processor to perform various operations. The operations include receiving, from a first computing device, safety hazard information associated with a first location. The operations include determining a hazard response operation to be performed based on the safety hazard information. The operations include determining, based on hazard response training data associated with a plurality of hazard responders, a set of hazard responders capable of performing the hazard response operation. The operations further include selecting a particular hazard responder from the set of hazard responders and sending instructions to a second computing device associated with the particular hazard responder. The instructions include information that identifies the first location.

In another particular embodiment, a computer-readable storage medium is disclosed. The computer-readable storage medium includes instructions that are executable by a processor to perform various operations. The operations include receiving, from a first computing device, safety hazard information associated with a first location. The operations include determining a hazard response operation to be performed based on the safety hazard information. The operations also include sending instructions to a second computing device associated with a particular hazard responder that is selected to perform the hazard response operation. The instructions include information that identifies the first location. The operations further include determining a reward to be provided to a user associated with the first computing device for providing the safety hazard information. The reward is determined based at least in part on a hazard response type associated with the hazard response operation.

The features, functions, and advantages that have been described can be achieved independently in various embodiments or may be combined in other embodiments, further details of which are disclosed with reference to the following description and drawings.

### BRIEF DESCRIPTION OF THE DRAWINGS

FIG. 1 is a diagram illustrating a system of rewarding a user for providing safety hazard information, according to one embodiment;

FIG. 2 is a diagram illustrating a system of sending instructions to computing device(s) associated with hazard responder(s) selected to perform hazard response operation(s) responsive to receiving safety hazard information, according to one embodiment;

FIG. 3 is a diagram illustrating a system of determining emergency response operation(s) to be performed responsive to an emergency response request, according to one embodiment;

FIG. 4 is a diagram illustrating a system of sending instructions to computing device(s) associated with emergency responder(s) selected to perform particular emergency response operation(s) responsive to receiving an emergency response request, according to one embodiment;

FIG. 5 is a flow chart illustrating a particular embodiment of a method of rewarding a user for providing safety hazard information;

FIG. 6 is a flow chart illustrating a particular embodiment of a method of sending instructions to computing device(s) associated with emergency responder(s) selected to perform emergency response operation(s) responsive to an emergency response request; and

FIG. 7 is an illustration of a block diagram of a computing environment including a general purpose computing device configured to support embodiments of computer-implemented methods and computer-executable program instructions (or code) according to the present disclosure.

### DETAILED DESCRIPTION

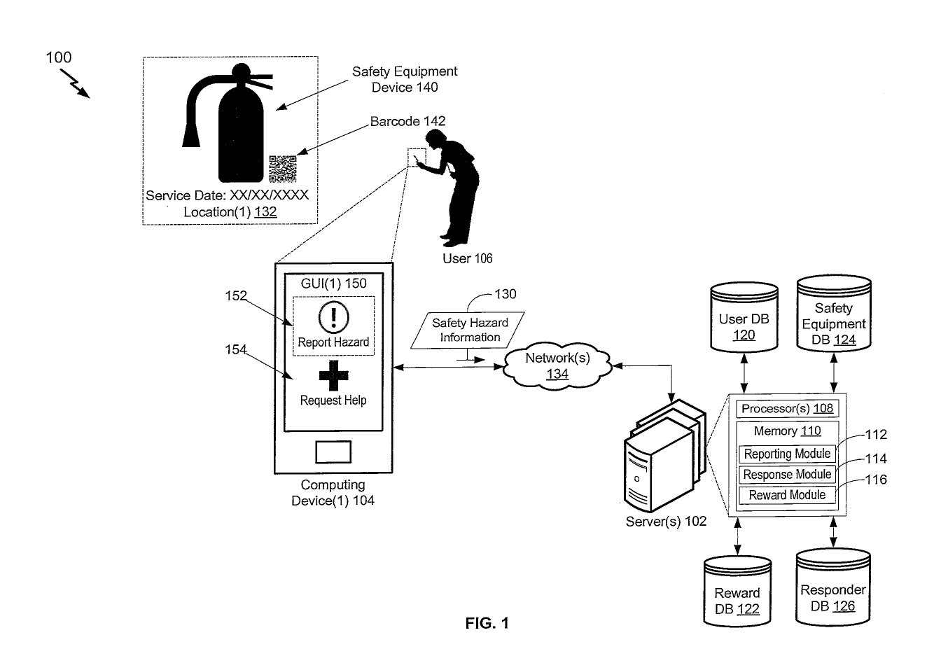

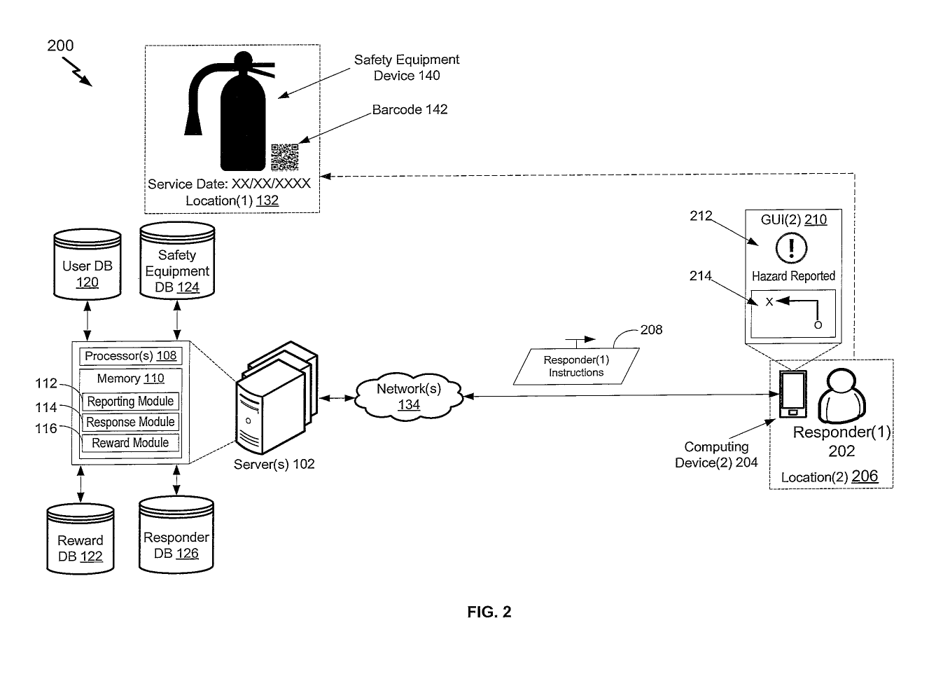

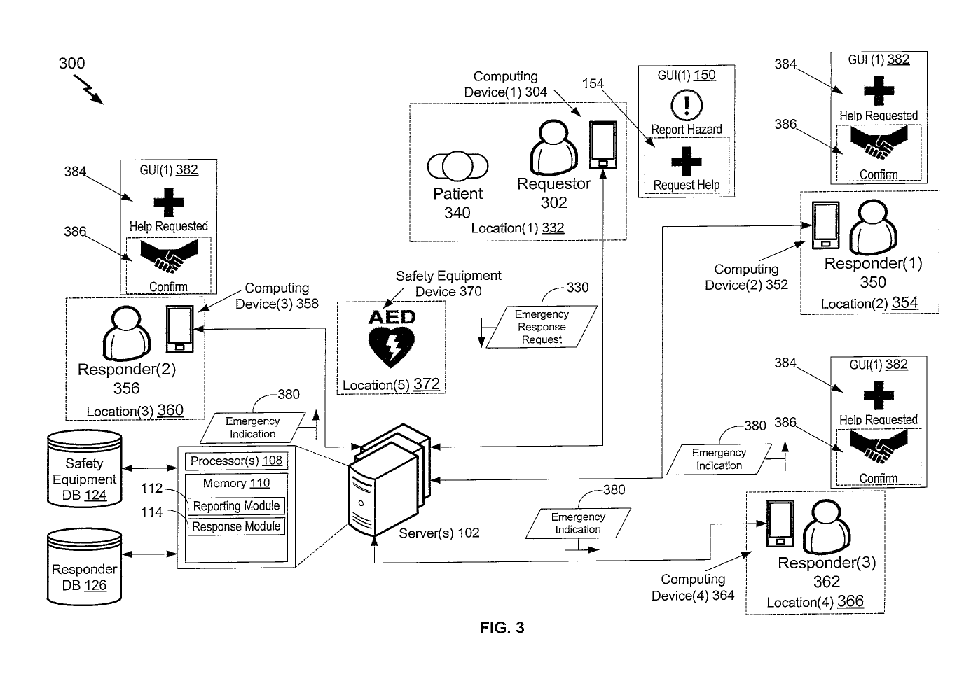

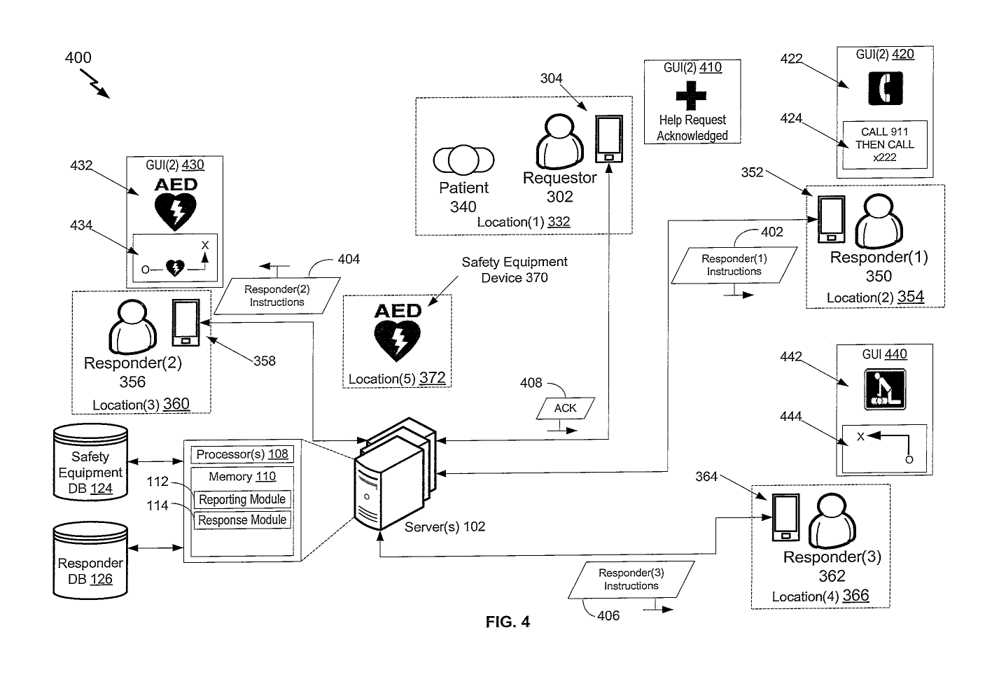

The present disclosure describes incentivizing a user to identify and report safety hazards (e.g., in a workplace environment) by rewarding the user, as described further herein with respect to FIGS. 1 and 2. The present disclosure further describes selecting emergency responders for an emergency situation (e.g., in a workplace environment), as described further herein with respect to FIGS. 3 and 4.

FIG. 1 illustrates an example of a system to incentivize a user to identify/report a safety hazard by providing a reward to the user (e.g., reward points associated with a workplace safety program). Additionally, as described further herein with respect to FIG. 2, the information identifying the safety hazard may be utilized to select hazard responder(s) to be dispatched to the location of the safety hazard, potentially improving safety hazard response time and/or reducing a likelihood of workplace injury resulting from the safety hazard.

Referring to FIG. 1, a particular embodiment of a system for rewarding a user for providing safety hazard information is illustrated and generally designated 100. In FIG. 1, a user may identify a safety hazard and may provide information associated with the safety hazard (e.g., by scanning a barcode of a safety equipment device, by photographing a safety hazard, etc.). As described further herein, a user may be incentivized to identify/report a safety hazard by providing a reward to the user (e.g., reward points associated with a workplace safety program).

In the particular embodiment illustrated in FIG. 1, the system 100 includes a server 102 (or multiple servers) and a first computing device 104. FIG. 1 illustrates that a user 106 is associated with the first computing device 104. While the first computing device 104 is illustrated in the example of FIG. 1 as a phone, it will be appreciated that alternative devices may be utilized. Further, while components of the first computing device 104 (e.g., a processor, memory, etc.) are not shown in the example of FIG. 1, it will be appreciated that the first computing device 104 may include hardware, software, or a combination thereof (such as a workplace safety application, a camera, etc.) for identifying/reporting a safety hazard.

The server 102 includes a processor 108 (or multiple processors) and a memory 110 in communication with the processor 108. The memory 110 stores instructions that are executable by the processor 108 to perform various operations. In the example of FIG. 1, the memory 110 includes a reporting module 112, a response module 114, and a reward module 116. FIG. 1 further illustrates that a user database 120, a reward database 122, a safety equipment database 124, and a responder database 126 may be accessible to the server 102.

The reporting module 112 of the server 102 may be configured to receive safety hazard information 130 from the first computing device 104 (associated with a first location 132 in the example of FIG. 1). For example, the safety hazard information 130 may be sent from the first computing device 104 to the server 102 via a network 134 (or multiple networks). As described further herein with respect to FIG. 2, the response module 114 of the server 102 may be configured to determine a hazard response operation to be performed based on the safety hazard information 130. In some cases, the safety hazard information 130 may include location data that identifies the first location 132. In a particular embodiment, the location data may include a set of global positioning system (GPS) coordinates associated with the first computing device 104. Alternatively, the location data may include information associated with another positioning system (e.g., a local positioning system that identifies a location within a workplace, such as a particular building, a location within the particular building, etc.). In other cases, the safety hazard information 130 may include an image, and the first location 132 may be determined (at the server 102) based on information extracted from the image (e.g., a sign or other identifier extracted from the image). In other cases, the user 106 may provide information that identifies the first location 132, and the information may be included in the safety hazard information 130 that is sent to the server 102.

The reward module 116 of the server 102 is configured to determine a reward to be provided to the user 106 associated with the first computing device 104 for providing the safety hazard information 130. To illustrate, the reporting module 112 may be configured to access the user database 120 to identify the user 106 associated with the first computing device 104, and the reward module 116 may be configured to access the reward database 122 to determine the reward. In some cases, the reward may be determined based at least in part on a hazard response type (e.g., a fire hazard response, a broken glass hazard response, etc.) associated with the particular hazard response operation(s) to be performed. In some cases, the reward may further be determined based on a number of safety hazards identified by the user 106. In some cases, the number of safety hazards identified by the user 106 (along with information associated with other users not shown in FIG. 1) may be stored at the user database 120 and/or the reward database 122.

As described further herein with respect to FIG. 2, the response module 114 may be configured to select a particular hazard responder (or multiple hazard responders) to perform one or more hazard response operations responsive to receiving the safety hazard information 130. For example, the response module 114 may access the responder database 126 to select one or more hazard responders. The response module 114 may be configured to send instructions from the server 102 to computing device(s) associated with the selected hazard responder(s). In some cases, the instructions sent to the computing device(s) of the selected hazard responder(s) may include information that identifies the first location 132 (e.g., to assist a hazard responder with locating the particular safety hazard).

In operation, the user 106 may utilize the first computing device 104 to capture information associated with a safety hazard. FIG. 1 shows an illustrative, non-limiting example in which the safety hazard information 130 includes information associated with the safety equipment device 140. It will be appreciated that the safety hazard information 130 may correspond to a fire hazard, a chemical spill hazard, a lighting hazard, a tripping hazard, a broken glass hazard, a broken tool hazard, a cross-walk hazard, an iced surface hazard, or a machine guarding hazard, among other alternatives. Additionally, the safety hazard information 130 may correspond to a current emergency (e.g., a fire) or a non-emergency hazard condition (e.g., a fire extinguisher with low pressure or that is due for inspection). Further, while the safety equipment device 140 illustrated in the example of FIG. 1 is a fire extinguisher, it will be appreciated that the safety equipment device 140 may include an automated external defibrillator (AED) device, an eyewash station, or chemical/biological response equipment, among other alternatives.

FIG. 1 illustrates that the user 106 may utilize a camera or other device (e.g., a barcode scanner) to capture information associated with the safety equipment device 140. In the illustrative, non-limiting example of FIG. 1, the user 106 may visually examine a service date (identified as “XX/XX/XXXX” in FIG. 1) to determine whether the safety equipment device 140 is overdue for service/inspection and/or replacement. In the particular embodiment illustrated in FIG. 1, a barcode 142 (e.g., a matrix barcode) is associated with the safety equipment device 140. In this case, the user 106 may capture information associated with the barcode 142 (e.g., using a camera/scanner of the first computing device 104). The information associated with the barcode 142 may be sent as the safety hazard information 130 to the server 102 via the network 134. In other cases, the safety hazard information 130 may include a photograph of a safety hazard (e.g., an image of the service date “XX/XX/XXXX” of the safety equipment device 140). Depending on a type of safety hazard encountered by the user 106, the photograph of the safety hazard may include a photograph of a fire hazard, a chemical spill hazard, a lighting hazard, a tripping hazard, a broken glass hazard, a broken tool hazard, a cross-walk hazard, an iced surface hazard, or a machine guarding hazard, among other alternatives.

In the particular embodiment illustrated in FIG. 1, a first graphical user interface 150 (identified as “GUI(1)” in FIG. 1) associated with a workplace safety application may be displayed at a display device of the first computing device 104. In the example of FIG. 1, the first GUI 150 includes a first selectable option 152 that allows the user 106 to report a safety hazard. In FIG. 1, a dashed line is used to illustrate that the first selectable option 152 has been selected by the user 106. Selection of the first selectable option 152 by the user 106 (e.g., before or after capturing information associated with the barcode 142, an image of the service date of the safety equipment device 140, etc.) may result in the safety hazard information 130 being sent from the first computing device 104 to the server 102. The first GUI 150 of FIG. 1 also includes a second selectable option 154 that allows the user 106 to request an emergency response, as described further herein with respect to FIGS. 3 and 4. While not shown in the example of FIG. 1, in some cases, the reporting module 112 may send an acknowledgment of receipt of the safety hazard information 130 to the first computing device 104 (e.g., for display to the user 106). Additionally, in some cases, the reporting module 112 may send alternative/additional information to the first computing device 104, such as a map to an exit, a location of an eyewash station, or a nearby telephone, among other alternatives. It will be appreciated that, in some cases, the particular information to be sent to the first computing device 104 may be determined at the server 102 based on a nature/type of safety hazard, an urgency of addressing the safety hazard, the first location 132, the user 106, or a combination thereof (among other alternatives). Further, in some cases, the reward module 116 may send reward information associated with the reward to be provided to the user 106 (e.g., for display at the first computing device 104).

Thus, FIG. 1 illustrates an example of a system to incentivize a user to identify/report a safety hazard by providing a reward to the user (e.g., reward points associated with a workplace safety program). Additionally, as described further herein with respect to FIG. 2, the identified safety hazard may be utilized to select hazard responder(s) to be dispatched to the location of the safety hazard, potentially increasing safety hazard response time and/or reducing a likelihood of workplace injury resulting from the safety hazard.

FIG. 2 illustrates a particular embodiment of a system 200 for sending instructions to computing device(s) associated with hazard responder(s) selected to perform hazard response operation(s) responsive to receiving safety hazard information. While not shown in FIG. 2, the safety hazard information may correspond to the safety hazard information 130 received from the first computing device 104 associated with the first location 132 (as illustrated and described herein with respect to FIG. 1).

In the particular embodiment illustrated in FIG. 2, the system 200 includes a first hazard responder 202 (identified as “Responder(1)” in FIG. 2) and a second computing device 204 associated with the first hazard responder 202. FIG. 2 illustrates that the second computing device 204 is located at a second location 206 (that is different from the first location 132). As described further herein, the response module 114 is configured to select the first hazard responder 202 and to send instructions 208 (identified as “Responder(1) Instructions” in FIG. 2) to the first hazard responder 202. While FIG. 2 illustrates an example of a single hazard responder being selected, it will be appreciated that an alternative number of hazard responders may be selected (e.g., based on a number and/or type of hazard response operations to be performed at the first location 132).

The responder database 126 may include information associated with a plurality of hazard responders, such as hazard response training data for each potential hazard responder or an area of responsibility (e.g., responsibility for a particular building, a portion of a building, an area of a factory, etc.). As illustrative, non-limiting examples, the hazard response training data may indicate whether a hazard responder has received chemical response training or biological response training, among other alternatives. The response module 114 may utilize information stored at the responder database 126 to determine a set of hazard responders (e.g., one or more hazard responders) that are capable of (or responsible for) performing a particular hazard response operation. The responder database 126 may include location data associated with each hazard responder of the set of hazard responders. Alternatively, the response module 114 may select a set of responders, query devices associated with the responders for location information, and select particular responder(s) from the set of responders based on location response(s). As another example, the response module 114 may identify a set of responders based on location information associated with the responders and select particular responder(s) with appropriate training/credentials. In some cases, the response module 114 may be configured to select a particular hazard responder (or multiple hazard responders) based on a comparison of location data associated with each hazard responder of the set of hazard responders to the first location 132.

In operation, the reporting module 112 receives safety hazard information from a computing device associated with the first location 132. For example, referring to FIG. 1, the reporting module 112 may receive the safety hazard information 130 from the first computing device 104. The response module 114 determines the hazard response operation(s) to be performed based on the safety hazard information 130. As an example, different hazard response rules may be associated with particular types of safety hazards, locations, time (e.g., during working hours, after working hours), or a combination thereof (among other alternatives). In the example of FIG. 2, the safety hazard at the first location 132 includes a fire extinguisher that is past a service/inspection date or that is due to be replaced. In this case, the response module 114 may determine that the hazard response operation to be performed at the first location 132 includes servicing/inspecting/replacing the safety equipment device 140.

In the example illustrated in FIG. 2, the first hazard responder 202 is selected to perform the hazard response operation (e.g., servicing/inspecting/replacing the safety equipment device 140). The response module 114 may send the instructions 208 to the second computing device 204 associated with the first hazard responder 202. As illustrative, non-limiting examples, the instructions 208 may include data for use by a workplace safety application of the second computing device 204, a short message service (SMS) message, or an email message. In some cases, the response module 114 may determine a method of delivery for the instructions 208 based on security information, an urgency of a response to the particular safety hazard, a distance from the second location 206 to the first location 132, or a combination thereof (among other alternatives).

FIG. 2 illustrates that, in some cases, the instructions 208 may include information that identifies the first location 132. In the particular embodiment illustrated in FIG. 2, the second computing device 204 is configured to display a second user interface 210 (identified as “GUI(2)” in FIG. 2) associated with a safety hazard application responsive to receiving the instructions 208 from the server 102. The second GUI 210 illustrated in FIG. 2 includes an indication 212 that a safety hazard has been reported and information 214 that identifies the first location 132. In the particular embodiment illustrated in FIG. 2, the information 214 includes a graphical illustration of a route from the second location 206 to the first location 132. In other cases, the information 214 may include textual information, graphical information, audible information, or a combination thereof. Alternatively or additionally, the information 214 may include information associated with the user 106 that provided the safety hazard information 130, an image captured by the user 106, equipment to be utilized when responding to the safety hazard (e.g., a replacement fire extinguisher, service equipment, etc.), or a combination thereof (among other possibilities).

In a particular embodiment, the safety hazard information (e.g., the safety hazard information 130 of FIG. 1) may include location data that identifies the first location 132. As an example, the location data may include a set of GPS coordinates (or location-specific data, such as a particular building) associated with the first computing device 104 (not shown in FIG. 2, see FIG. 1). As another example, information associated with the safety hazard (e.g., information associated with the barcode 142 of the safety equipment device 140) may be compared to information stored at the safety equipment database 124 in order to identify the first location 132. Alternatively, a user (e.g., the user 106 of FIG. 1) may provide information associated with the first location 132 to the server 102 (e.g., as part of the safety hazard information 130).

In some cases, the response module 114 may select a particular hazard responder (e.g., the first hazard responder 202 in the example of FIG. 2) based on a comparison of the first location 132 to location data associated with each potential hazard responder. To illustrate, the responder database 126 may include location information (e.g., GPS coordinates, workplace facility location, etc.) for a plurality of potential hazard responders. In this case, the response module 114 may select the first hazard responder 202 based on a comparison of the first location 132 to the second location 206. While FIG. 2 illustrates an example of the selection of a single hazard responder, it will be appreciated that other hazard responders may be located at other locations, and the response module 114 may select the first responder 202 as the particular hazard responder to be dispatched to the first location 132 based on a relative proximity of the second location 206 to the first location 132.

While not shown in the example of FIG. 2, the first hazard responder 202 may provide information via the second computing device 204 (e.g., an acknowledgment to the server 102). As illustrative, non-limiting example, the response module 114 may assign an end date (e.g., inspect/replace the safety equipment device 140 within a particular time period), request confirmation of completion of the safety hazard response, store information associated with the request/response (e.g., for reporting purposes, or a combination thereof (among other alternatives. Thus, the system 200 of FIG. 2 is an illustrative, non-limiting example of a system for responding to a particular safety hazard. It will be appreciated that alternative and/or additional safety hazard response operation(s) may be performed. Further, alternative and/or additional information may be communicated from the server 102 to the second computing device 204, from the second computing device 204 to the server 102, or a combination thereof.

Thus, FIG. 2 illustrates that a location of a safety hazard identified by a user (e.g., the user 106 of FIG. 1) may be utilized to select hazard responder(s) to be dispatched to the location in order to perform hazard response operation(s), potentially reducing safety hazard response time and/or reducing a likelihood of workplace injury resulting from the safety hazard.

FIG. 3 illustrates an example of a system for determining emergency response operation(s) to be performed responsive to an emergency response request. When multiple emergency response operations are to be performed, particular responders may be selected based on emergency response training/capabilities of potential responders, locations of the potential responders relative to the location of the emergency response request and/or a safety equipment device, or a combination thereof. FIG. 4 illustrates that the location of an emergency that is identified by a requestor may be utilized to select particular emergency responder(s) to be dispatched to the location to perform particular emergency response operation(s), potentially reducing emergency response time and/or serious workplace injuries/deaths.

FIG. 3 illustrates a particular embodiment of a system 300 for determining emergency response operation(s) to be performed responsive to an emergency response request. In FIG. 3, a requestor may send an emergency response request from a computing device associated with a location of an emergency, and a server may determine one or more emergency response operations to be performed based on the emergency response request. When multiple emergency response operations are to be performed, particular responders may be selected based on emergency response training/capabilities of potential responders, locations of the potential responders relative to the location of the emergency response request and/or a safety equipment device (for use in responding to the emergency), or a combination thereof. Illustrative examples of emergency response operations include calling emergency telephone number(s), performing cardiopulmonary resuscitation (CPR), retrieving/utilizing an AED device, performing mitigation activities, providing logistical support, or providing response coordination, among other alternatives.

In the particular embodiment illustrated in FIG. 3, a requestor 302 is associated with a first computing device 304. The reporting module 112 of the server 102 is configured to receive an emergency response request 330 from the first computing device 304 (associated with a first location 332 in the example of FIG. 3). The emergency response request 330 may be sent from the first computing device 304 to the server 102 via a network (or multiple networks), not shown in FIG. 3. As described further herein, the response module 114 of the server 102 is configured to determine one or more emergency response operations to be performed based on the emergency response request 330. In some cases, the emergency response request 330 may include location data that identifies the first location 332. In a particular embodiment, the location data may include a set of GPS coordinates associated with the first computing device 304. Alternatively, the location data may include information associated with another positioning system (e.g., a local positioning system that identifies a location within a workplace, such as a particular building, a location within the particular building, etc.). In other cases, the emergency response request 330 may include an image, and the first location 332 may be determined (at the server 102) based on information extracted from the image (e.g., a sign or other identifier extracted from the image). In other cases, the requestor 302 may provide information that identifies the first location 332, and the information may be included in the emergency response request 330 that is sent to the server 102.

The response module 114 may be configured to select a particular emergency responder (or multiple emergency responders) to perform one or more emergency response operations responsive to receiving the emergency response request 330. For example, the response module 114 may access the responder database 126 to select one or more emergency responders. As illustrated and further described herein with respect to FIG. 4, the response module 114 may be configured to send instructions from the server 102 to computing device(s) associated with emergency responder(s) that are selected to perform particular emergency response operation(s). In some cases, the instructions sent to the computing device(s) of the selected emergency responder(s) may include information that identifies the first location 332 (e.g., to aid an emergency responder in locating the particular emergency).

In the particular embodiment illustrated in FIG. 3, the system 300 includes a first emergency responder 350 (identified as “Responder(1)” in FIG. 3) and a second computing device 352 associated with the first emergency responder 350. FIG. 3 illustrates that the second computing device 352 is located at a second location 354 (that is different from the first location 332). FIG. 3 also illustrates a second emergency responder 356 (identified as “Responder(2)” in FIG. 3) and a third computing device 358 associated with the second emergency responder 356. FIG. 3 illustrates that the third computing device 358 is located at a third location 360 (that is different from the first location 332). FIG. 3 further illustrates a third emergency responder 362 (identified as “Responder(3)” in FIG. 3) and a fourth computing device 364 associated with the third emergency responder 362. FIG. 3 illustrates that the fourth computing device 364 is located at a fourth location 366 (that is different from the first location 332).

While the computing devices 304, 352, 358, 364 are illustrated in the example of FIG. 3 as phones, it will be appreciated that alternative devices may be utilized. Further, while components of the computing devices 304, 352, 358, 364 (e.g., a processor, memory, etc.) are not shown in the example of FIG. 3, it will be appreciated that the computing devices 304, 352, 358, 364 may include hardware, software, or a combination thereof (such as a workplace safety application). As described further herein, the workplace safety application stored at the computing devices 304, 352, 358, 364 may be utilized to report an emergency and to provide information associated with the emergency, such as a nature of the emergency (e.g., a possible heart attack), information associated with the patient 340, location information, or a combination thereof.

As described further herein with respect to FIG. 4, the response module 114 is configured to select the first emergency responder 350 to perform a first emergency response operation (e.g., call one or more emergency telephone numbers) and to send first instructions 402 (identified as “Responder(1) Instructions” in FIG. 4) to the first emergency responder 350. The response module 114 is configured to select the second emergency responder 356 to perform a second emergency response operation (e.g., to retrieve and deliver an AED device to the emergency location) and to send second instructions 404 (identified as “Responder(2) Instructions” in FIG. 4) to the second emergency responder 356. The response module 114 is configured to select the third emergency responder 362 to perform a third emergency response operation (e.g., perform CPR) and to send third instructions 406 (identified as “Responder(3) Instructions” in FIG. 4) to the third emergency responder 362. While FIG. 3 illustrates an example of three emergency responders being selected, it will be appreciated that an alternative number of emergency responders may be selected (e.g., based on a number and/or type of emergency response operations to be performed at the first location 332).

The responder database 126 may include information associated with a plurality of emergency responders, such as emergency response training data for each potential emergency responder. The response module 114 may utilize information stored at the responder database 126 to determine a set of emergency responders (e.g., one or more emergency responders) that are capable of performing a particular emergency response operation. As an illustrative example, a first emergency response operation may include performing cardiopulmonary resuscitation (CPR), and the emergency response training data may identify whether each emergency responder of the plurality of emergency responders has received CPR training. In this case, the response module 114 may utilize information stored at the responder database 126 to determine that at least the third emergency responder 362 has received CPR training and is capable of performing CPR, as described further herein with respect to FIG. 4.

The responder database 126 may further include location data associated with each emergency responder of the set of emergency responders. In some cases, the response module 114 may be configured to select a particular emergency responder (or multiple emergency responders) based on a comparison of location data associated with each emergency responder of the set of emergency responders to the first location 332. FIG. 3 illustrates that, in some cases, a potential emergency responder may be located at a location that is closer to the first location 332, but another potential emergency responder that is located at a location that is further away from the first location 332 depending on the particular type of emergency response operation(s) to be performed. As an illustrative example, a distance from the second location 354 (associated with the first emergency responder 350) to the first location 332 may be less than a distance from the fourth location 366 (associated with the third emergency responder 362). However, the response module 114 may determine, based on information stored at the responder database 126, that the first responder 350 has not received CPR training, while the third responder 362 has received CPR training. In this case (as illustrated and further described herein with respect to FIG. 4), the third responder 362 may be selected to perform CPR, while the first responder 350 may be selected to perform another emergency response operation (e.g., calling one or more emergency telephone numbers).

The safety equipment database 124 may include location data associated with multiple safety equipment devices (e.g., AED devices, first aid kits, telephones, etc.). In some cases, the response module 114 may be configured to identify a particular safety equipment device associated with a particular emergency response operation. As an illustrative example, FIG. 3 illustrates a safety equipment device 370 (e.g., an AED device) that is located at a fifth location 372 (that is different from the first location 332). In this example, the response module 114 may be configured to select the second emergency responder 356 to perform an emergency response operation that includes retrieving the safety equipment device 370 from the fifth location 372 and delivering the safety equipment device 370 to the first location 332. In some cases, the second emergency responder 356 may be selected to perform this particular emergency response operation based on a comparison of location data associated with the second emergency responder 356, the first location 332, and the third location 360.

In operation, the requestor 302 may utilize the first computing device 104 to send the emergency response request 330. In the particular embodiment illustrated in FIG. 3, the emergency response request 330 is associated with a patient 340 that may be experiencing symptoms associated with a heart attack (among other possible symptoms/conditions/injuries). It will be appreciated that, in other cases, the patient 340 may utilize another device (such as a computing device) to request emergency assistance. In the example illustrated in FIG. 3, the first graphical user interface 150 associated with the workplace safety application may be displayed at a display device of the first computing device 304. The first GUI 150 includes the second selectable option 154 that allows the requestor 302 to request an emergency response. In some cases, the first GUI 150 may include other selectable options and/or text input areas to allow the requestor 302 to identify a nature of the emergency (e.g., that the patient 340 is not breathing, etc.). In FIG. 3, a dashed line is used to illustrate that the second selectable option 154 has been selected by the requestor 302 (with the corresponding emergency response request 330 sent to the server 102). As illustrated and further described herein with respect to FIG. 4, in some cases, the reporting module 112 may send an acknowledgment of receipt of the emergency response request 330 to the first computing device 304. Alternatively or additionally, in some cases, the response module 114 may send instructions to the requestor 302 (e.g., to clear the area, to open/unlock a door to allow entry by an emergency medical technician (EMT), to alert the patient 340 that help is on the way, etc.).

The reporting module 112 may receive the emergency response request 330 from the first computing device 304. The response module 114 may determine the particular emergency response operation(s) to be performed based on the emergency response request 330. In some cases, different emergency response rules may be associated with particular types of emergencies, locations, time (e.g., during working hours, after working hours), or a combination thereof (among other alternatives). As an illustrative, non-limiting example, the emergency at the first location 332 may include the patient 340 experiencing a heart attack. In this case, the response module 114 may determine that the particular emergency response operation(s) to be performed at the first location 332 include calling one or more emergency telephone numbers (e.g., 911, an internal emergency extension, or a combination thereof), performing CPR on the patient 340, and (potentially) using an AED device on the patient 340 (e.g., in the event that CPR is unsuccessful). As another example, the reporting module 112 may perform one or more non-response reporting operations (such as alerting a facility manager that an emergency has been reported, etc.).

FIG. 3 illustrates that the response module 114 selects the first responder 350 to perform a first emergency response operation (e.g., calling one or more emergency telephone numbers) and sends an emergency indication 380 to the second computing device 362 (e.g., a phone in the example of FIG. 3) associated with the first responder 350. The emergency indication 380 may include textual information, graphical information, audible information, or a combination thereof. FIG. 3 further illustrates that the second computing device 352 is configured to display a user interface 382 (identified as “GUI(1)” in FIG. 3) associated with a safety application responsive to receiving an emergency indication 380 from the server 102. In the example of FIG. 3, the user interface 382 includes an indication 384 of an emergency response request and a first selectable option 386 to send an acknowledgement of receipt of the emergency indication 380 to the server 102. In FIG. 3, a dashed line is used to illustrate that the first selectable option 386 has been selected by the first emergency responder 350. As illustrated and further described herein with respect to FIG. 4, the response module 114 may send further information to the second computing device 352 (e.g., after receiving confirmation from the first responder 350 of an availability to respond to the emergency).

FIG. 3 also illustrates that the response module 114 selects the second responder 356 to perform a second emergency response operation (e.g., retrieving and delivering an AED device) and sends the emergency indication 380 to the third computing device 358 associated with the second responder 356. The emergency indication 380 may include textual information, graphical information, audible information, or a combination thereof. FIG. 3 further illustrates that the third computing device 358 associated with the second emergency responder 356 is configured to display the user interface 382 (identified as “GUI(1)” in FIG. 3) associated with the safety application responsive to receiving the emergency indication 380 from the server 102. In FIG. 3, a dashed line is used to illustrate that the first selectable option 386 has been selected by the second emergency responder 356. As illustrated and further described herein with respect to FIG. 4, the response module 114 may send further information to the third computing device 358 (e.g., after receiving confirmation from the second responder 356 of an availability to respond to the emergency).

FIG. 3 further illustrates that the response module 114 selects the third responder 362 to perform a third emergency response operation (e.g., performing CPR) and sends the emergency indication 380 to the fourth computing device 364 associated with the third responder 362. The emergency indication 380 may include textual information, graphical information, audible information, or a combination thereof. FIG. 3 further illustrates that the fourth computing device 364 associated with the third emergency responder 362 is configured to display the user interface 382 (identified as “GUI(1)” in FIG. 3) associated with the safety application responsive to receiving the emergency indication 380 from the server 102. In FIG. 3, a dashed line is used to illustrate that the first selectable option 386 has been selected by the third emergency responder 362. As illustrated and further described herein with respect to FIG. 4, the reporting module 112 may send further information to the fourth computing device 364 (e.g., after receiving confirmation from the third responder 362 of an availability to respond to the emergency).

In some cases, when a responder declines a request or when the server 102 does not receive an acknowledgment confirming an availability of an emergency responder within a threshold amount of time (e.g., one minute), the response module 112 may select one or more alternate emergency responders. The response module 114 may send the emergency indication 380 to the alternate emergency responder(s). To illustrate, in the event that the third emergency responder 362 fails to confirm an availability to respond to the emergency (e.g., via selection of the first selectable option 386) within the threshold amount of time, the response module 114 may select a fourth emergency responder (not shown in FIG. 3) to perform the emergency response operation(s) originally assigned to the third responder 362. It will be appreciated that, in the event that the server 102 does not receive acknowledgments from multiple responders, the response module 114 may continue to select alternate responder(s) until sufficient responders have confirmed availability to respond to the emergency.

Thus, FIG. 3 illustrates an example of a system for determining emergency response operation(s) to be performed responsive to an emergency response request. When multiple emergency response operations are to be performed, particular responders may be selected based on emergency response training/capabilities of potential responders, locations of the potential responders relative to the location of the emergency response request and/or a safety equipment device, or a combination thereof.

Referring to FIG. 4, a particular embodiment of a system 400 for sending instructions to computing device(s) associated with emergency responder(s) selected to perform emergency response operation(s) responsive to an emergency response request. While not shown in FIG. 4, the emergency response request may correspond to the emergency response information 330 received from the first computing device 304 associated with the first location 332 (as illustrated and further described herein with respect to FIG. 3).

FIG. 4 illustrates that the response module 114 is configured to send first instructions 402 (illustrated as “Responder(1) Instructions” in FIG. 4) to the second computing device 352 associated with the first emergency responder 350. As described further herein, the first emergency responder 350 is selected (by the response module 114) to perform a first emergency response operation responsive to the emergency response request 330 (as shown in FIG. 3).

FIG. 4 also illustrates that the response module 114 is configured to send second instructions 404 (illustrated as “Responder(2) Instructions” in FIG. 4) to the third computing device 358 associated with the second emergency responder 356. As described further herein, the second emergency responder 356 is selected (by the response module 114) to perform a second emergency response operation responsive to the emergency response request 330 (as shown in FIG. 3).

FIG. 4 further illustrates that the response module 114 is configured to send third instructions 406 (illustrated as “Responder(3) Instructions” in FIG. 4) to the fourth computing device 364 associated with the third emergency responder 362. As described further herein, the third emergency responder 362 is selected (by the response module 114) to perform a third emergency response operation responsive to the emergency response request 330 (as shown in FIG. 3).

In the particular embodiment illustrated in FIG. 4, the response module 114 may be configured to send an acknowledgement 408 (identified as “ACK” in FIG. 4) to the first computing device 304 associated with the requestor 302. FIG. 4 illustrates that a user interface 410 (identified as “GUI(2)” in FIG. 4) may be displayed at the first computing device 304 in response to receiving the acknowledgment 408.

In operation, the response module 114 sends the first instructions 402 to the second computing device 352 associated with the first emergency responder 350 (e.g., via a network, not shown in FIG. 4). The response module 112 also sends the second instructions 404 to the third computing device 358 associated with the second emergency responder 356. The response module 112 further sends the third instructions 406 to the fourth computing device 364 associated with the third emergency responder 362. While the terms first, second, and third are used herein to describe instructions that are sent to particular emergency responders, it will be appreciated that the instructions may be sent from the server 102 substantially simultaneously or in any particular sequence.

FIG. 4 illustrates that the second computing device 352 associated with the first emergency responder 350 displays a user interface 420 (identified as “GUI(2)” in FIG. 4) associated with the workplace safety application responsive to receiving the first instructions 402 from the server 102. In the example of FIG. 4, the user interface 420 displayed at the second computing device 352 includes an image 422 to provide an indication of a particular emergency response operation to be performed by the first emergency responder 350. To illustrate, the image 422 (e.g., an image of a telephone) indicates that the first emergency responder 350 is assigned the task of calling one or more emergency telephone numbers. While not shown in the example of FIG. 4, in some cases, the user interface 420 may include a first selectable option to send an acknowledgment of receipt of the first instructions 402 to the server 102.

FIG. 4 further illustrates that additional information 424 may be provided in order to assist the first emergency responder 350 with performing the first emergency response operation (e.g., a reminder to first dial 911 and then dial an internal workplace emergency number). While not shown in the example of FIG. 4, the user interface 420 may include a second selectable option to send an indication to the server 102 that an emergency response operation has been completed. In some cases, the user interface 420 may allow the first responder 350 to send an acknowledgment that a sequence of steps have been performed. Alternatively, the user interface 420 may allow the first responder 350 to send individual acknowledgments after completing a particular step, such as sending a first acknowledgement that a first step (e.g., dialing 911) has been performed, then sending a second acknowledgment that a second step (e.g., dialing x222) has been performed.

FIG. 4 illustrates that the third computing device 358 associated with the second emergency responder 356 displays a user interface 430 (identified as “GUI(2)” in FIG. 4) associated with the workplace safety application responsive to receiving the second instructions 404 from the server 102. In the example of FIG. 4, the user interface 430 displayed at the third computing device 358 includes an image 432 to provide an indication of a particular emergency response operation to be performed by the second emergency responder 356. To illustrate, the image 432 (e.g., an image of an AED device) indicates that the second emergency responder 356 is assigned the task of retrieving and/or utilizing an AED device. While FIG. 4 illustrates an example of an image being presented via the user interface 430, it will be appreciated that the user interface 430 may include text, voice, video, or a combination thereof. As an illustrative, non-limiting example, the user interface 430 may include a photograph of the patient 340 captured by the requestor 302 using a camera of the first computing device 304. FIG. 4 further illustrates that additional information 434 may be provided in order to assist the second emergency responder 356 with performing the second emergency response operation. In the example of FIG. 4, the user interface 430 includes a graphical illustration of a route from the second location 360 to the fifth location 372 associated with the safety equipment device 370 (for retrieval of the AED device from the fifth location 372 for potential use at the first location 332). The graphical illustration further includes a route from the fifth location 372 to the first location 332 (for delivery/utilization of the AED device). While not shown in the example of FIG. 4, the user interface 430 may include a selectable option to allow the second emergency responder 356 to confirm that the safety equipment device 370 has been retrieved from the fifth location 372 and/or a selectable option to allow the second emergency responder 356 to confirm that the safety equipment device 370 has been delivered to the first location 332.

FIG. 4 illustrates that the fourth computing device 364 associated with the third emergency responder 362 displays a user interface 440 (identified as “GUI(2)” in FIG. 4) associated with the workplace safety application responsive to receiving the third instructions 406 from the server 102. In the example of FIG. 4, the user interface 440 displayed at the fourth computing device 364 includes an image 442 to provide an indication of a particular emergency response operation to be performed by the third emergency responder 362. To illustrate, the image 442 (e.g., an image of a responder performing CPR on a patient) indicates that the third emergency responder 362 is assigned the task of performing CPR on the patient 340. While FIG. 4 illustrates an example of an image being presented via the user interface 440, it will be appreciated that the user interface 440 may include text, voice, video, or a combination thereof. FIG. 4 further illustrates that additional information 444 may be provided in order to assist the third emergency responder 363 with performing the third emergency response operation. In the example of FIG. 4, the user interface 440 includes a graphical illustration of a route from the fourth location 366 to the first location 444. While not shown in the example of FIG. 4, the user interface 440 may include a selectable option to allow the third emergency responder 362 to confirm that CPR has been performed on the patient 340.

Thus, FIG. 4 illustrates an example of a system for sending instructions to computing devices associated with multiple emergency responders that are selected to perform emergency response operations responsive to an emergency response request. A location of an emergency that is identified by a requestor or that is identified automatically (e.g., based on information from the first computing device 304) may be utilized to select particular emergency responder(s) to be dispatched to the location to perform particular emergency response operation(s), potentially reducing emergency response time and/or serious workplace injuries/deaths.

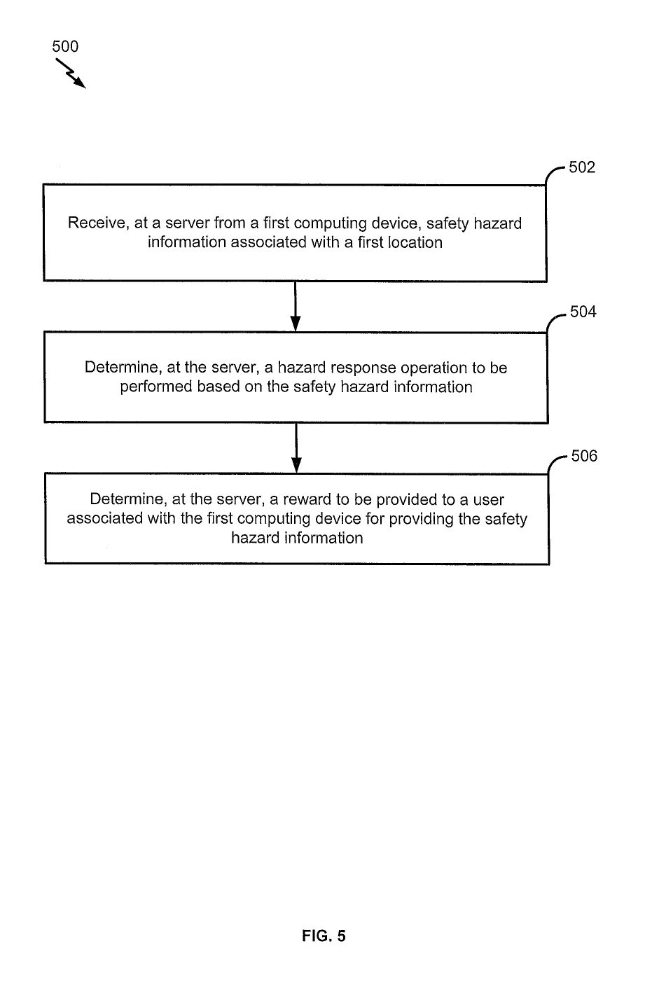

FIG. 5 illustrates a particular embodiment of a method 500 of rewarding a user for providing safety hazard information. In FIG. 5, a reward may be used to incentivize a user to identify/report a safety hazard (e.g., as a part of a workplace safety program). As further described herein with respect to FIG. 2, the identified safety hazard may be utilized to select hazard responder(s) to be dispatched to the location of the safety hazard, potentially reducing safety hazard response time and/or a likelihood of workplace injury resulting from the safety hazard.

The method 500 includes receiving, at a server from a first computing device, safety hazard information associated with a first location, at 502. For example, referring to FIG. 1, the server 102 may receive (e.g., via the network 134) the safety hazard information 130 from the first computing device 104. The computing device 104 may be associated with the first location 132. As described further herein with respect to FIG. 1, in some cases, the user 106 may utilize a camera or other device (e.g., a barcode scanner) of the first computing device 104 to capture information associated with a particular safety hazard. In the example of FIG. 1, the user 106 may capture information associated with the barcode 142 of the safety equipment device 140, and the information may be sent to the server 102 as the safety hazard information 130. In other cases, the safety hazard information 130 may include a photograph of a safety hazard (e.g., an image of the service date “XX/XX/XXXX” of the safety equipment device 140). Depending on a type of safety hazard encountered by the user 106, the photograph of the safety hazard may include a photograph of a fire hazard, a chemical spill hazard, a lighting hazard, a tripping hazard, a broken glass hazard, a broken tool hazard, a cross-walk hazard, an iced surface hazard, or a machine guarding hazard, among other alternatives.

The method 500 includes determining, at the server, a hazard response operation to be performed based on the safety hazard information, at 504. For example, referring to FIGS. 1 and 2, the response module 114 of the server 102 may determine one or more hazard response operations to be performed based on the safety hazard information 130. In the example of FIGS. 1 and 2, the safety hazard at the first location 132 includes a fire extinguisher that is past a service/inspection date or that is due to be replaced. In this case, the response module 114 may determine that the hazard response operation(s) to be performed at the first location 132 includes servicing/inspecting/replacing the safety equipment device 140.

The method 500 includes determining, at the server, a reward to be provided to a user associated with the first computing device for providing the safety hazard information, at 506. For example, referring to FIG. 1, the reporting module 112 of the server 102 may access the user database 120 to identify the user 106 associated with the first computing device 104, and the reward module 116 may access the reward database 122 to determine the reward. In some cases, the reward may be determined based at least in part on a hazard response type (e.g., a fire hazard response, a broken glass hazard response, etc.) associated with the particular hazard response operation(s) to be performed. In some cases, the reward may further be determined based on a number of safety hazards identified by the user 106. In some cases, the number of safety hazards identified by the user 106 (along with information associated with other users not shown in FIG. 1) may be stored at the user database 120 and/or the reward database 122.

Thus, FIG. 5 illustrates an example of a method of incentivizing a user to identify/report a safety hazard by providing a reward to the user (e.g., reward points associated with a workplace safety program).

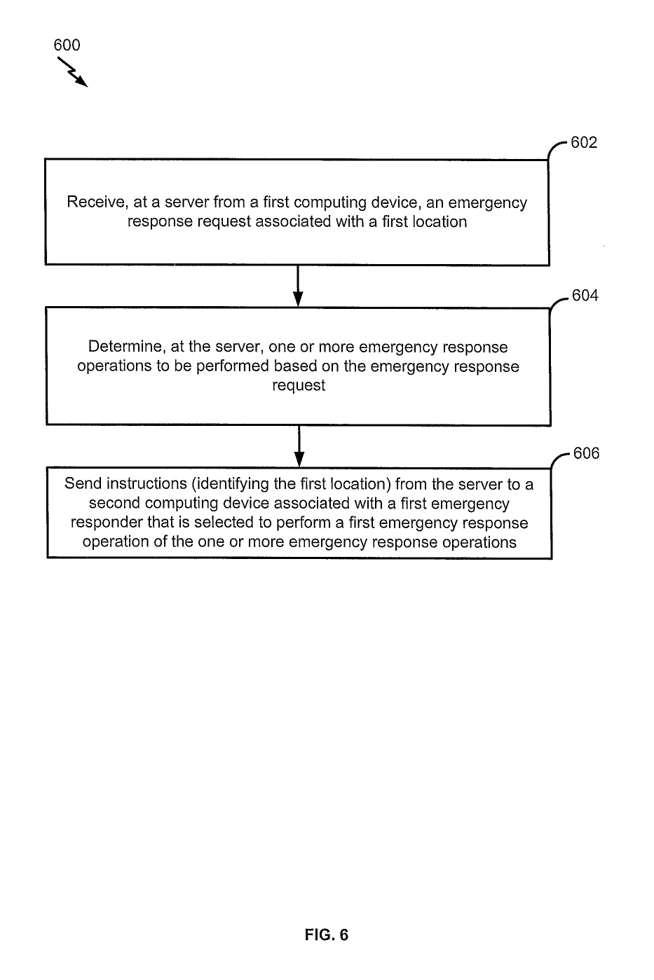

FIG. 6 illustrates a particular embodiment of a method 600 of sending instructions to computing device(s) associated with emergency responder(s) selected to perform emergency response operation(s) responsive to an emergency response request. As further described herein with respect to FIGS. 3 and 4, emergency responder(s) may be dispatched to a location of an emergency, potentially reducing emergency response time and/or a likelihood of a serious workplace injury/death.

The method 600 includes receiving, at a server from a first computing device, an emergency response request associated with a first location, at 602. For example, referring to FIG. 3, the reporting module 112 of the server 102 may receive the emergency response request 330 associated with the first location 332 from the first computing device 304.

The method 600 includes determining, at the server, one or more emergency response operations to be performed based on the emergency response request, at 604. For example, as described further herein with respect to FIGS. 3 and 4, the response module 114 of the server 102 may determine that multiple emergency response operations are to be performed responsive to the emergency response request 330. In the example illustrated in FIG. 4, a first emergency response operation (to be performed by the first emergency responder 350) may include calling one or more emergency telephone numbers. FIG. 4 further illustrates that a second emergency response operation (to be performed by the second emergency responder 356) may include retrieving/delivering/utilizing the safety equipment device 470 (e.g., an AED device). FIG. 4 further illustrates that a third emergency response operation (to be performed by the third emergency responder 362) may include performing CPR on the patient 340.

The method 600 includes sending instructions from the server to a second computing device associated with a first emergency responder, at 606. The first emergency responder may be selected to perform a first emergency response operation of the one or more emergency response operations. In some cases, the instructions may identify the first location (associated with the emergency). For example, referring to FIG. 4, the server 102 may send the first instructions 402 to the second computing device 352 associated with the first emergency responder 350. FIG. 4 illustrates that the first emergency responder 350 may be assigned the task of calling one or more emergency telephone numbers. In this case, the first instructions 402 may not identify the first location 332. Alternatively, referring to FIG. 4, the second instructions 404 sent to the second emergency responder 356 identify the first location 332 (e.g., via the graphical illustration in the user interface 430). As another example, referring to FIG. 4, the third instructions 406 sent to the third emergency responder 362 identify the first location 332 (e.g., via the graphical illustration in the user interface 440).

Thus, FIG. 6 illustrates an example of a method of dispatching emergency responder(s) to a location of an emergency, potentially reducing emergency response time and/or a likelihood of serious workplace injury/death.

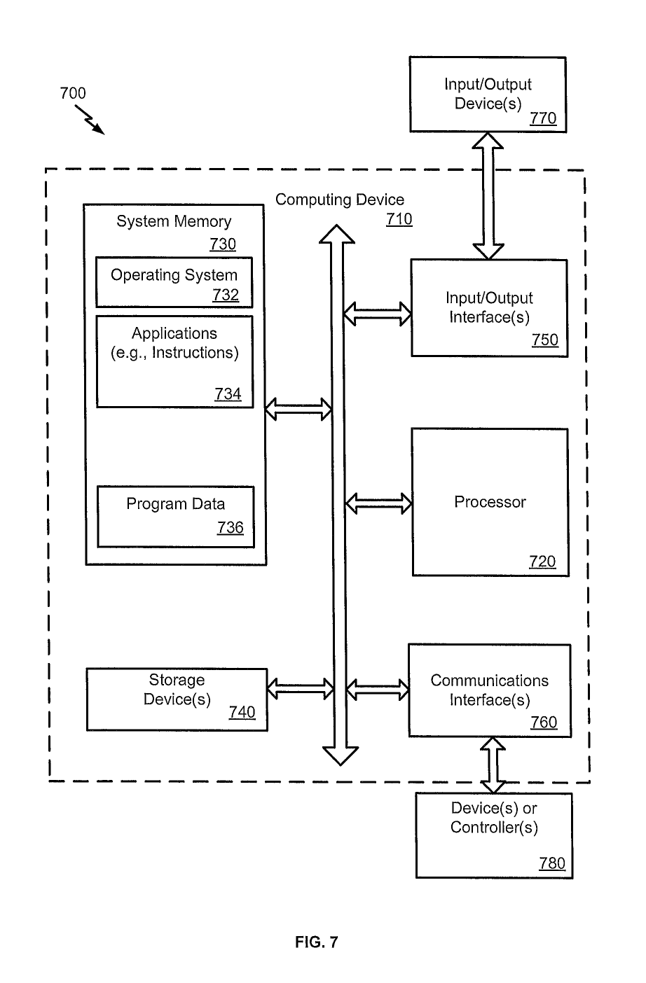

FIG. 7 is an illustration of a block diagram of a computing environment 700 including a general purpose computing device 710 configured to support embodiments of computer-implemented methods and computer-executable program instructions (or code) according to the present disclosure. The computing device 710, or portions thereof, may further execute instructions according to any of the methods described herein. In a particular embodiment, the computing device 710 of FIG. 7 may correspond to the server(s) 102 illustrated in FIGS. 1-4. Alternatively, the computing device 710 of FIG. 7 may correspond to one or more of the computing devices 104, 204, 304, 352, 358, 364 illustrated in FIGS. 1-4.

The computing device 710 may include a processor 720. The processor 720 may communicate with the system memory 730, one or more storage devices 740, one or more input/output interfaces 750, one or more communications interfaces 760, or a combination thereof. The system memory 730 may include volatile memory devices (e.g., random access memory (RAM) devices), nonvolatile memory devices (e.g., read-only memory (ROM) devices, programmable read-only memory, and flash memory), or both. The system memory 730 may include an operating system 732, which may include a basic/input output system for booting the computing device 710 as well as a full operating system to enable the computing device 710 to interact with users, other programs, and other devices. The system memory 730 may include one or more applications 734 which may be executable by the processor 720. For example, the one or more applications 734 may include instructions executable by the processor 720 to perform various operations. Further, the system memory 730 may include program data 736 usable for performing various operations described herein.

As an example, the application(s) 734 may include instructions executable by the processor 720 to receive safety hazard information from a first computing device associated with a first location. The application(s) 734 may also include instructions executable by the processor 720 to determine a hazard response operation to be performed based on the safety hazard information. The application(s) 734 may further include instructions executable by the processor 720 to determine, based on hazard response training data associated with a plurality of hazard responders, a set of hazard responders capable of performing the hazard response operation. In some cases, the hazard response training data may be stored at the storage device(s) 740 of the computing device 710. The application(s) 734 may also include instructions executable by the processor 720 to select a particular hazard responder from the set of hazard responders. The application(s) 734 may further include instructions executable by the processor 720 to send instructions to a second computing device associated with the particular hazard responder. The instructions sent to the second computing device may include information that identifies the first location.

As another example, the application(s) 734 may include instructions executable by the processor 720 to receive safety hazard information from a first computing device associated with a first location. The application(s) 734 may include instructions executable by the processor 720 to determine a hazard response operation to be performed based on the safety hazard information. The application(s) 734 may include instructions executable by the processor 720 to send instructions to a second computing device associated with a particular hazard responder that is selected to perform the hazard response operation. The instructions sent to the second computing device may include information that identifies the first location. The application(s) 734 may include instructions executable by the processor 720 to determine a reward to be provided to a user associated with the first computing device for providing the safety hazard information based at least in part on a hazard response type associated with the hazard response operation.

As a further example, the application(s) 734 may include instructions that are executable by the processor 720 to receive an emergency response request from a first computing device associated with a first location. The application(s) 734 may include instructions that are executable by the processor 720 to determine a set of emergency response operations to be performed based on the emergency response request. The set of emergency response operations may include at least a first emergency response operation and a second emergency response operation. The application(s) 734 may include instructions that are executable by the processor 720 to select a first emergency responder to perform the first emergency response operation and to select a second emergency responder to perform the second emergency response operation. The application(s) 734 may include instructions that are executable by the processor 720 to send first instructions to a second computing device associated with the first emergency responder and to send second instructions to a third computing device associated with the second emergency responder.

As another example, the application(s) 734 may include instructions executable by the processor 720 to receive an emergency response request from a first computing device associated with a first location. The application(s) 734 may include instructions executable by the processor 720 to determine one or more emergency response operations to be performed based on the emergency response request. The application(s) 734 may include instructions executable by the processor 720 to select a first emergency responder to perform a first emergency response operation of the one or more emergency response operations. The application(s) 734 may include instructions executable by the processor 720 to send first instructions to a second computing device associated with the first emergency responder. The first instructions sent to the second computing device may identify the first location.

As a further example, when the computing device 710 of FIG. 7 corresponds to one of the computing devices 104, 204, 304, 352, 358, 364 illustrated in FIGS. 1-4, the application(s) 734 may include instructions executable by the processor 720 to perform various operations. As an example, the application(s) 734 may include instructions executable by the processor 720 to display the user interface 150 of FIG. 1 and to send the safety hazard information 130 to the server 102. As another example, the application(s) 734 may include instructions executable by the processor 720 to display the user interface 210 of FIG. 2 and (optionally) to send information (e.g., an acknowledgment) to the server 102. As another example, the application(s) 734 may include instructions executable by the processor 720 to display the graphical user interface 382 of FIG. 3 and to send information (e.g., an acknowledgment) to the server 102. As a further example, the application(s) 734 may include instructions executable by the processor 720 to display one of the graphical user interfaces 410, 420, 430, 440 of FIG. 4 and (optionally) to send information (e.g., an acknowledgment of completion of one or more emergency response operations) to the server 102.

The processor 720 may also communicate with one or more storage devices 740. For example, the one or more storage devices 740 may include nonvolatile storage devices, such as magnetic disks, optical disks, or flash memory devices. The storage devices 740 may include both removable and non-removable memory devices. The storage devices 740 may be configured to store an operating system, images of operating systems, applications, and program data. In a particular embodiment, the memory 730, the storage devices 740, or both, include tangible computer-readable media. In a particular embodiment, the storage devices 740 illustrated in FIG. 7 may correspond to the user database 120 of FIGS. 1 and 2, the reward database 122 of FIGS. 1 and 2, the responder database 126 of FIGS. 1-4, the safety equipment database 124 of FIGS. 1-4, or a combination thereof.

The processor 720 may also communicate with one or more input/output interfaces 750 that enable the computing device 710 to communicate with one or more input/output devices 770 to facilitate user interaction. The processor 720 may detect interaction events based on user input received via the input/output interfaces 750. Additionally, the processor 720 may send a display to a display device via the input/output interfaces 750. The processor 720 may communicate with devices or controllers 780 via the one or more communications interfaces 760.

Embodiments described above are illustrative and do not limit the disclosure. It is to be understood that numerous modifications and variations are possible in accordance with the principles of the present disclosure.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, method steps may be performed in a different order than is shown in the figures or one or more method steps may be omitted. Accordingly, the disclosure and the figures are to be regarded as illustrative rather than restrictive.

Moreover, although specific embodiments have been illustrated and described herein, it is to be appreciated that any subsequent arrangement designed to achieve the same or similar results may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the claimed subject matter may be directed to less than all of the features of any of the disclosed embodiments.

What is claimed is:

1. A method comprising:
receiving, at a server from a first computing device, safety hazard information associated with a first location;
determining, at the server, a hazard response operation to be performed based on the safety hazard information; and
determining, at the server, a reward to be provided to a user associated with the first computing device for providing the safety hazard information.

2. The method of claim 1, wherein the reward is determined based at least in part on a hazard response type associated with the hazard response operation.

3. The method of claim 2, wherein the reward is further determined based on a number of safety hazards identified by a user associated with the first computing device.

4. The method of claim 1, further comprising sending instructions from the server to a second computing device associated with a particular hazard responder that is selected to perform the hazard response operation, wherein the instructions include information that identifies the first location.

5. The method of claim 4, wherein the second computing device is configured to display a user interface associated with a safety hazard application responsive to receiving the instructions from the server, and wherein the user interface includes the information that identifies the first location.

6. The method of claim 5, wherein the information that identifies the first location includes a graphical illustration of a route from a second location associated with the second computing device to the first location.

7. The method of claim 1, further comprising:
determining, based on hazard response training data associated with a plurality of hazard responders, a set of hazard responders capable of performing the hazard response operation; and
selecting, at the server, the particular hazard responder from the set of hazard responders to be dispatched to the first location.

8. The method of claim 7, wherein the particular hazard responder is selected based on a comparison of location data associated with each hazard responder of the set of hazard responders to the first location.

9. The method of claim 1, wherein the safety hazard information includes information associated with a safety equipment device.

10. The method of claim 9, wherein the safety equipment device is a fire extinguisher, an automated external defibrillator (AED) device, or an eyewash station.

11. The method of claim 9, wherein the information associated with the safety equipment device includes information associated with a barcode of the safety equipment device.

12. The method of claim 11, wherein the barcode includes a matrix barcode.

13. The method of claim 1, wherein the safety hazard information includes a photograph of a safety hazard.

14. The method of claim 1, wherein the safety hazard information corresponds to a fire hazard, a chemical spill hazard, a lighting hazard, a tripping hazard, a broken glass hazard, a broken tool hazard, a cross-walk hazard, an iced surface hazard, or a machine guarding hazard.

15. A system comprising:
a processor;
a memory in communication with the processor, the memory including instructions executable by the processor to perform operations including:
receiving, from a first computing device, safety hazard information associated with a first location;
determining a hazard response operation to be performed based on the safety hazard information;
determining, based on hazard response training data associated with a plurality of hazard responders, a set of hazard responders capable of performing the hazard response operation;
selecting a particular hazard responder from the set of hazard responders; and
sending instructions to a second computing device associated with the particular hazard responder, wherein the instructions include information that identifies the first location.

16. The system of claim 15, wherein the safety hazard information includes location data that identifies the first location, wherein the particular hazard responder is selected based on a comparison of location data associated with each hazard responder of the set of hazard responders to the first location.

17. The system of claim 16, wherein the location data includes a set of global positioning system (GPS) coordinates associated with the first computing device.

18. The system of claim 15, wherein the safety hazard information includes an image, the operations further comprising determining the first location based on information extracted from the image.

19. A computer-readable storage medium comprising instructions that are executable by a processor to perform operations including:
receiving, from a first computing device, safety hazard information associated with a first location;
determining a hazard response operation to be performed based on the safety hazard information;
sending instructions to a second computing device associated with a particular hazard responder that is selected to perform the hazard response operation, wherein the instructions include information that identifies the first location; and
determining a reward to be provided to a user associated with the first computing device for providing the safety hazard information based at least in part on a hazard response type associated with the hazard response operation.

20. The computer-readable storage medium of claim 19, wherein the operations further include:
sending, to the first computing device, an acknowledgment of receipt of the safety hazard information; and
sending, to the first computing device, reward information associated with the reward to be provided to the user.
